(19) United States
(12) Patent Application Publication
(10) Pub. No.: US 2025/0292464 A1
(43) Pub. Date: Sep. 18, 2025

(54) SYSTEMS AND METHODS FOR USING AI TO FACILITATE IMAGE EDITING

(71) Applicant: YAHOO ASSETS LLC, New York, NY (US)

(72) Inventors: Kapil THADANI, New York, NY (US); Akshay BAHADUR, Scottsdale, AZ (US); Dipen RUGHWANI, Cupertino, CA (US); Paloma DE JUAN, New York, NY (US); Joao Vitor Baldini SOARES, New York, NY (US)

(21) Appl. No.: 19/071,830

(22) Filed: Mar. 6, 2025

Related U.S. Application Data
(60) Provisional application No. 63/564,799, filed on Mar. 13, 2024.

(51) Int. Cl. G06T 11/60; G06T 7/70; G06V 10/74

(52) U.S. Cl. CPC G06T 11/60; G06T 7/70; G06V 10/761; G06V 2201/07

(57) ABSTRACT

In some implementations, the techniques described herein relate to a method including: (i) identifying, by a processor, an image. (ii) receiving, by the processor, natural language instructions for editing the image, the natural language instructions including a location within the image and an editing instruction, (iii) editing, by a machine learning model executed by the processor, the location within the image based on the natural language instructions by (a) identifying a region within the image that corresponds to the location in the natural language instructions and (b) editing the identified region by applying the editing instruction to the identified region to generate an edited image, and (iv) causing, by the processor, display of the edited image.

### CROSS REFERENCE TO RELATED APPLICATIONS

This application claims the benefit of U.S. Provisional Patent Application No. 63/564,799 filed Mar. 13, 2024, the contents of which is hereby incorporated by reference.

### BACKGROUND

Various machine learning (ML) and artificial intelligence (AI) models are capable of generating images based on text input by a user. In some implementations, a generative ML model may take text as input from a user and output a generated image based at least partially on that text. However, generated images are often not exactly what a user wants and may require many iterations to refine. In some cases, a simple modification to one area of the image may be enough to produce the desired image, but a user may not be proficient with image editing tools and may be unable to manually make the desired edit.

### BRIEF DESCRIPTION OF THE DRAWINGS

FIG. 1 is a block diagram illustrating a system for using AI to facilitate image editing according to some of the example embodiments.

FIG. 2 is a flow diagram illustrating a method for using AI to facilitate image editing according to some of the example embodiments.

FIG. 3 is an illustration of a method for training AI to facilitate image editing according to some of the example embodiments.

FIG. 4 is an illustration of an example image produced by a method for using AI to facilitate image editing according to some of the example embodiments.

FIG. 5 is an illustration of a method for using AI to facilitate image editing in the form of a virtual fitting room according to some of the example embodiments.

FIG. 6 is a block diagram of a computing device according to some embodiments of the disclosure.

### DETAILED DESCRIPTION

The instant disclosure describes systems and methods for using AI to facilitate image editing. Various ML models are capable of generating or editing images. One example of such a model is a generative ML model. Generative ML models, often underpinned by Generative Adversarial Networks (GANs) or diffusion models as well as text-based transformer models, are trained on massive datasets of images and text prompts and can be used to generate images and/or edit images of various sizes and styles in response to text and/or image-based prompts. In some embodiments, an ML model may be composed of a neural network with many parameters (typically billions of weights or more). For example, an ML model may use a GAN to analyze training data and/or image inputs. In some implementations, an ML model may use multiple neural networks working in conjunction.

The example embodiments herein describe methods, computer-readable media, device, and systems that use AI to facilitate image editing by receiving natural language input from a user as well as an image to be edited and outputting the edited version of the image. In some embodiments, the systems described herein may train an ML model to edit images via a set of triplets consisting of two images and a string of text that describes the difference between the two images. In one embodiment, the systems described herein may facilitate display of a virtual fitting room where a user can virtually try on different accessories by pairing images or models of the accessories with an image or model of the user.

In some implementations, the techniques described herein relate to a method including: (i) identifying, by a processor, an image, (ii) receiving, by the processor, natural language instructions for editing the image, the natural language instructions including a location within the image and an editing instruction, (iii) editing, by a machine learning model executed by the processor, the location within the image based on the natural language instructions by (a) identifying a region within the image that corresponds to the location in the natural language instructions and (b) editing the identified region by applying the editing instruction to the identified region to generate an edited image, and (iv) causing, by the processor, display of the edited image.

In some implementations, the techniques described herein relate to a method, wherein identifying the region within the image that corresponds to the location in the natural language instructions comprises identifying a landmark location within the image that is described by the natural language instructions.

In some implementations, the techniques described herein relate to a method, wherein identifying the region within the image that corresponds to the location in the natural language instructions comprises identifying a set of objects of a similar type depicted within the image and identifying, based on the natural language instructions, a specific object within the set of objects referred to by the natural language instructions.

In some implementations, the techniques described herein relate to a method, wherein identifying the region within the image that corresponds to the location in the natural language instructions comprises identifying a type of object described by the natural language instructions and locating an object of the type within the image.

In some implementations, the techniques described herein relate to a method, wherein identifying the region within the image that corresponds to the location in the natural language instructions comprises identifying a relative directional descriptor within the natural language instructions and identifying the region at least in part based on the relative directional descriptor.

In some implementations, the techniques described herein relate to a method, further comprising training the machine learning model by identifying a set of triplets that each comprise (i) an unmodified version of a training image, (ii) text that comprises a description of a location within the unmodified version of the training image, and (iii) a modified version of the training image that comprises a modification to the location described within the text and providing the set of triplets to the machine learning model as input data.

In some implementations, the techniques described herein relate to a method, wherein the image comprises a frame of a video.

In some implementations, the techniques described herein relate to a method, wherein editing, by the machine learning model executed by the processor, the location within the image based on the natural language instructions comprises editing consecutive frames of the video.

In some implementations, the techniques described herein relate to a non-transitory computer-readable storage medium for tangibly storing computer program instructions capable of being executed by a computer processor, the computer program instructions defining steps of: (i) identifying, by a processor, an image, (ii) receiving, by the processor, natural language instructions for editing the image, the natural language instructions including a location within the image and an editing instruction, (iii) editing, by a machine learning model executed by the processor, the location within the image based on the natural language instructions by (a) identifying a region within the image that corresponds to the location in the natural language instructions and (b) editing the identified region by applying the editing instruction to the identified region to generate an edited image, and (iv) causing, by the processor, display of the edited image.

In some implementations, the techniques described herein relate to a non-transitory computer-readable storage medium, wherein identifying the region within the image that corresponds to the location in the natural language instructions comprises identifying a landmark location within the image that is described by the natural language instructions.

In some implementations, the techniques described herein relate to a non-transitory computer-readable storage medium, wherein identifying the region within the image that corresponds to the location in the natural language instructions comprises identifying a set of objects of a similar type depicted within the image and identifying, based on the natural language instructions, a specific object within the set of objects referred to by the natural language instructions.

In some implementations, the techniques described herein relate to a non-transitory computer-readable storage medium, wherein identifying the region within the image that corresponds to the location in the natural language instructions comprises identifying a type of object described by the natural language instructions and locating an object of the type within the image.

In some implementations, the techniques described herein relate to a non-transitory computer-readable storage medium, wherein identifying the region within the image that corresponds to the location in the natural language instructions comprises identifying a relative directional descriptor within the natural language instructions and identifying the region at least in part based on the relative directional descriptor.

In some implementations, the techniques described herein relate to a non-transitory computer-readable storage medium, further comprising training the machine learning model by identifying a set of triplets that each comprise (i) an unmodified version of a training image, (ii) text that comprises a description of a location within the unmodified version of the training image, and (iii) a modified version of the training image that comprises a modification to the location described within the text and providing the set of triplets to the machine learning model as input data.

In some implementations, the techniques described herein relate to a non-transitory computer-readable storage medium, wherein the image comprises a frame of a video.

In some implementations, the techniques described herein relate to a non-transitory computer-readable storage medium, wherein the image comprises editing, by the machine learning model executed by the processor, the location within the image based on the natural language instructions comprises editing consecutive frames of the video.

In some implementations, the techniques described herein relate to a device including: a processor; and a storage medium for tangibly storing thereon logic for execution by the processor, the logic including instructions for: (i) identifying, by a processor, an image, (ii) receiving, by the processor, natural language instructions, the natural language instructions including a location within the image and an editing instruction, (iii) editing, by a machine learning model executed by the processor, the location within the image based on the natural language instructions by (a) identifying a region within the image that corresponds to the location in the natural language instructions and (b) editing the identified region by applying the editing instruction to the identified region to generate an edited image, and (iv) causing, by the processor, display of the edited image.

In some implementations, the techniques described herein relate to a device, wherein identifying the region within the image that corresponds to the location in the natural language instructions comprises identifying a landmark location within the image that is described by the natural language instructions.

In some implementations, the techniques described herein relate to a device, wherein identifying the region within the image that corresponds to the location in the natural language instructions comprises identifying a set of objects of a similar type depicted within the image and identifying, based on the natural language instructions, a specific object within the set of objects referred to by the natural language instructions.

In some implementations, the techniques described herein relate to a device, wherein identifying the region within the image that corresponds to the location in the natural language instructions comprises identifying a type of object described by the natural language instructions and locating an object of the type within the image.

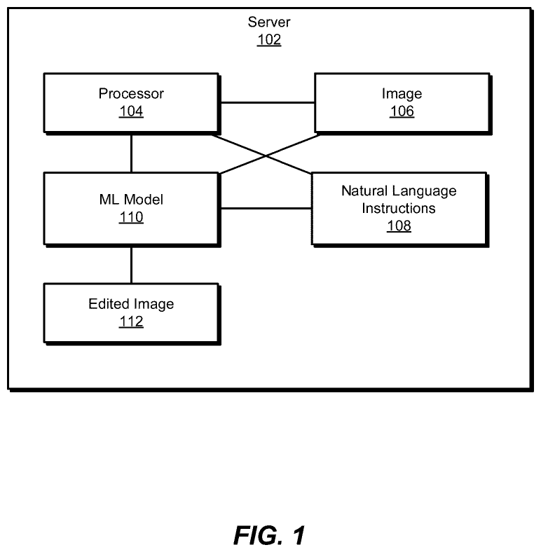

FIG. 1 is a block diagram illustrating a system for using AI to facilitate image editing according to some of the example embodiments.

The illustrated system includes a server 102. Server 102 may host a processor 104 that identifies an image 106 and receives natural language instructions 108 for editing image 106 that refer to a location within image 106. In one implementation, an ML model 110 executed by processor 104 may edit the location within image 106 conforming to natural language instructions 108 by identifying a region within image 106 that corresponds to the location in natural language instructions 108 and editing the identified region by applying the editing instruction to the identified region to generate an edited image 112. Next, processor 104 may cause display of edited image 112. Although illustrated here on server 102, any or all of the systems described herein may be hosted by one or more client devices, servers, and/or cloud-based processing resources. Further details of these components are described herein and in the following flow diagrams.

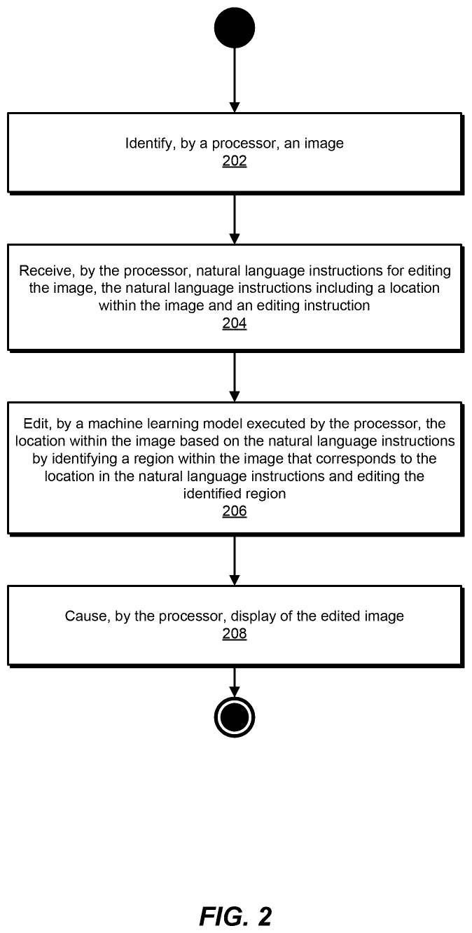

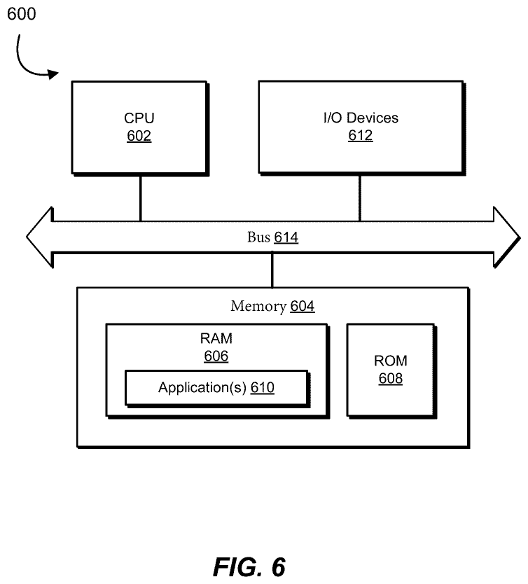

In the various implementations, server 102, processor 104, and/or ML model 110 can be implemented using various types of computing devices such as laptop/desktop devices, mobile devices, server computing devices, etc. Specific details of the components of such computer devices are provided in the description of FIG. 6 which are not repeated herein. In general, these devices can include a processor and a storage medium for tangibly storing thereon logic for execution by the processor. In some implementations, the logic can be stored on a non-transitory computer readable storage medium for tangibly storing computer program instructions. In some implementations, these instructions can implement some of all of the method described in FIG. 2.

In some implementations, image 106 can comprise a digital image file. In some examples, image 106 may be a digital image file generated by a generative ML model. Additionally, or alternatively, image 106 may be a digital image file that originated as a photograph, digital painting, screenshot, scanned image, and/or any other suitable source for a digital image file. In some examples, image 106 may be a frame of a video file. In one implementation, image 106 may be a three-dimensional model or vector file that the systems described herein convert into a raster image for editing purposes. Similarly, edited image 112 can comprise any of the aforementioned types of image. In some examples, edited image 112 may comprise the same type of image as image 106. Alternatively, the systems described herein may modify the type (e.g., file type, resolution, color profile, etc.) of the image being edited and edited image 112 may comprise a different type of digital image file than image 106.

In some implementations, natural language instructions 108 may include user input in a human-readable language. In some examples, natural language instructions 108 may not conform to any specific formatting such as key-value pairs, comma-separated values, predefined keywords, grid coordinates, etc., and instead may include casual phrasing. In some examples, natural language instructions 108 may include relative directional descriptors such as, “left,” “right,” “third from the right,” “lower,” and so forth. Additionally, or alternatively, natural language instructions 108 may include other types of relative descriptions to distinguish between objects of a similar type, such as “larger,” “smaller,” “foreground,” “background,” and the like.

FIG. 2 is a flow diagram illustrating a method for using AI to facilitate image editing according to some of the example embodiments.

In step 202, the method can include identifying, by a processor, an image.

In some implementations, the method may receive an image as user input. For example, the method may receive the image in tandem with receiving the natural language instructions in step 204. In one implementation, the method may enable a user to upload an image to be edited. Additionally, or alternatively, the method may enable a user to browse a gallery of images to select an image to be edited. In some implementations, the systems described herein may include a generative ML model that generates the image.

In some examples, the image may be a frame from a video and the method may receive the image by receiving the video file. In these examples, the method may process multiple frames of the video file consecutively and/or concurrently in order to produce an edited video file with consistent changes across multiple frames.

In step 204, the method can include receiving, by the processor, natural language instructions for editing the image, the natural language instructions including a location within the image and an editing instruction.

In some implementations, the method may receive the natural language instructions via a text input field in a graphical user interface (GUI). Additionally, or alternatively, the method may receive the natural language instructions as speech captured by an audio receiver of a device and may perform speech-to-text processing on the natural language instructions. In some implementations, the method may receive the natural language instructions via the same GUI that receives the image to be edited as input.

In some implementations, the natural language instructions may describe a location within the image and a change to be made to the location. In some examples, the natural language instructions may refer to the location by describing an object at the location.

### Example Natural Language Instructions:

“Color my hair blue.”

“Replace the dog with a cat.”

“Remove the man from the picture.”

“Make the top of the image darker.”

“Add fireworks to the sky in the picture.”

“Recolor all of the traffic cones from orange to yellow.”

In some examples, an image may include multiple objects of the same or a similar type. For example, an image may include multiple people, multiple dogs, and so forth, and a user may only wish to edit specific instances of these rather than all of them. In these examples, the natural language instructions may include relative directional terms and/or other types of relative terms to distinguish one object from another.

### Example Natural Language Instructions With Relative Terms:

“Color the hair blue on the woman in the center.”
“Replace the dog on the left side with a cat.”
“Remove the man in the background from the picture.”
“Add fireworks to the sky in the top left of the picture.”
“Recolor all of the traffic cones on the left side of the street from orange to yellow.”

In some implementations, the systems described herein may be configured to receive input that specifies multiple locations, such as, “Replace the dog on the left side with a cat and color the woman's hair blue.” In other implementations, the systems described herein may be configured to receive input that specifies a single location. In some examples, the systems described herein may receive input in multiple steps and/or perform multiple rounds of edits.

In step 206, the method can include editing, by an ML model executed by the processor, the location within the image based on the natural language instructions by identifying a region within the image that corresponds to the location in the natural language instructions and editing the identified region.

The ML model may identify the region within the image in a variety of ways. In some examples, the natural language instructions may include a landmark location within the image. For example, the ML model may use referring expression comprehension to identify the location within the image from the natural language instructions.

In one embodiment, the ML model may edit the identified region by applying the editing instruction to the identified region to generate an edited image. In some implementations, the ML model may identify the region by identifying an object described in the natural language instructions. For example, the ML model may have been trained on training data that includes images of cats accompanied by text-based descriptions of cats and may therefore be able to identify a cat within an image in response to receiving text-based instructions referring to a cat.

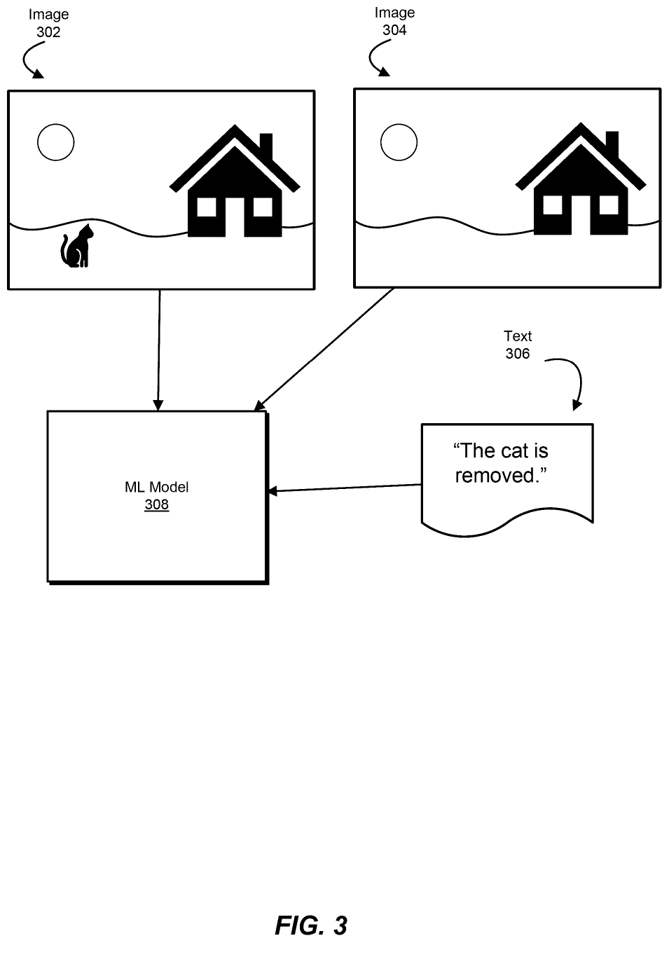

In some examples, the ML model may be trained by receive a set of triplets that each include an unmodified version of a training image, text with a description of a location within the unmodified version of the training image, and a modified version of the training image with a modification to the location described within the text. For example, as illustrated in FIG. 3, an ML model 308 may receive an image 302, an image 304, and text 306 that describes the difference between image 302 and image 304. By providing many such triplets as training data to the ML model, the systems described herein may train the ML model to identify various types of objects and/or location descriptors within images.

In some examples, the systems described herein may provide triplets with differences in types, number, location, attributes, and/or actions being performed by objects within the images and accompanying descriptive text in order to train the ML model to identify these features.

### Example Text:

“A third car has been added.”
“The dog is running instead of sitting.”
“The woman's hair is black instead of grey.”
“The chair is rotated ninety degrees.”

In one implementation, the systems described herein may generate the triplets to provide to the ML model as training data in an automated fashion. For example, the systems described herein may identify an annotated image with metadata that describes at least one location in the image and may create a modified version of the annotated image by using an inpainting technique with masking bounded according to the annotation. In this example, the systems described herein may provide the annotated image, the modified image, and text based on the annotation to the ML model as training data. In some examples, the systems described herein may identify a set of annotated images and produce a set of triplets from the set of annotated images.

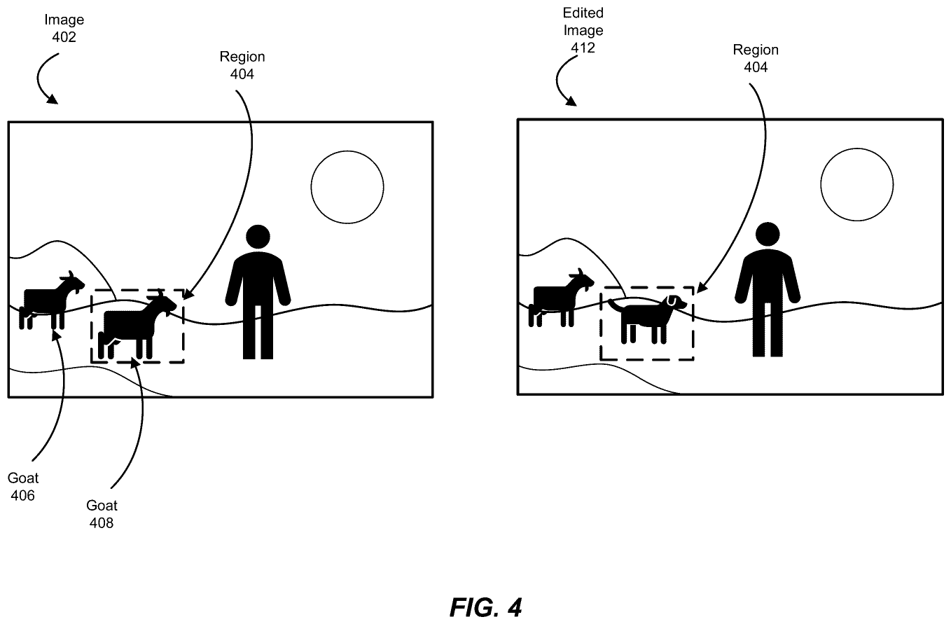

In some implementations, the systems described herein may train the ML model to identify locations and/or objects described with relative directional terms. For example, as illustrated in FIG. 4, the systems described herein may receive an image 402 to be edited along with natural language text such as, “replace the goat on the right with a dog.” In this example, the ML model may recognize goat 406 and goat 408 as goats and may identify goat 408 as being the goat on the right, thereby identifying region 404 that includes goat 408 as the region that corresponds to the location within the natural language instructions. In this example, the ML model may edit region 404 to produce edited image 412, where region 404 is occupied by a dog instead of a goat.

The ML model may edit region 404 in a variety of ways. For example, the ML model may use an inpainting technique to continue the background over the goat, erasing the goat, before painting a dog on top of the new background area. In other examples, the ML model may use different techniques to add objects, recolor objects, modify objects, and/or remove objects from an image. For example, the ML model may use generative ML techniques to generate new objects to add to images and/or to generate modified versions of objects within images. In some examples, the ML model may use optical character recognition (OCR) techniques to identify and/or modify text within an image.

The systems described herein may train an ML model to recognize various types of natural language expressions such as counting, geometry, verbs, and/or attributes. For example, in an image with multiple dogs of different colors performing different activities, the systems described herein may receive the natural language instruction, “replace the white dog with a border collie” and may correctly identify the dog with the attribute of white fur while not editing the brown, black, or grey dogs. In another example, the systems described herein may receive the natural language instruction, “replace the sleeping dog with a cat” and may correctly edit the sleeping dog while not editing the sitting, running, or jumping dogs.

Returning to FIG. 2, in step 208, the method can include causing, by the processor, display of the edited image.

The processor may cause display of the edited image in a variety of ways. For example, the processor may transmit the edited image to a client device (e.g., a personal computing device such as a laptop or mobile device) for display on a screen of the client device. In some implementations, the systems described herein may cause display of the edited image in the same GUI used to receive the image to be edited and/or the natural language instructions.

In some examples, the systems described herein may receive further natural language instructions to further edit the image and may repeat steps 204-208 until the user is satisfied with the edited image.

Example Initial Image: A black cat sitting in the front yard of a single-story house on a sunny day.

Example Instructions: Replace the cat with a dog.

Example Edited Image: A medium-sized brown dog of ambiguous breed sitting in the front yard of a single-story house on a sunny day.

Example Additional Instructions: Make the dog a golden retriever.

Example Re-edited Image: A golden retriever sitting in the front yard of a single-story house on a sunny day.

In some implementations, the systems described herein may edit a video by editing multiple frames of the video. For example, the systems described herein may receive a video as input as well as natural language instructions to change the baseball in the video to a glowing orb. In this example, the systems described herein may process each frame of video as a separate image, identifying the baseball in each frame that includes the baseball, replacing the baseball with a glowing orb, then reassembling all of the frames into an edited version of the video.

In some examples, the systems described herein may enable users to create product advertisements, virtual home remodels, and/or other product-centered images by replacing dummy or existing products in an image with specific branded products. For example, the systems described herein may receive an image of a kitchen that includes a generic microwave and may, based on natural language instructions, replace the generic microwave with a specific branded microwave. In another example, the systems described herein may receive an image of an advertisement with last season's jackets and may replace those jackets in the image with the current season's jackets.

In some implementations, the systems described herein may edit images within a virtual fitting room to enable a user to virtually try on accessories. Accessories may generally refer to any wearable item that does not provide substantial body coverage. For example, a shirt or pair of pants may not be an accessory while a hat, pair of glasses, watch, handbag, belt, and/or necktie may be an accessory.

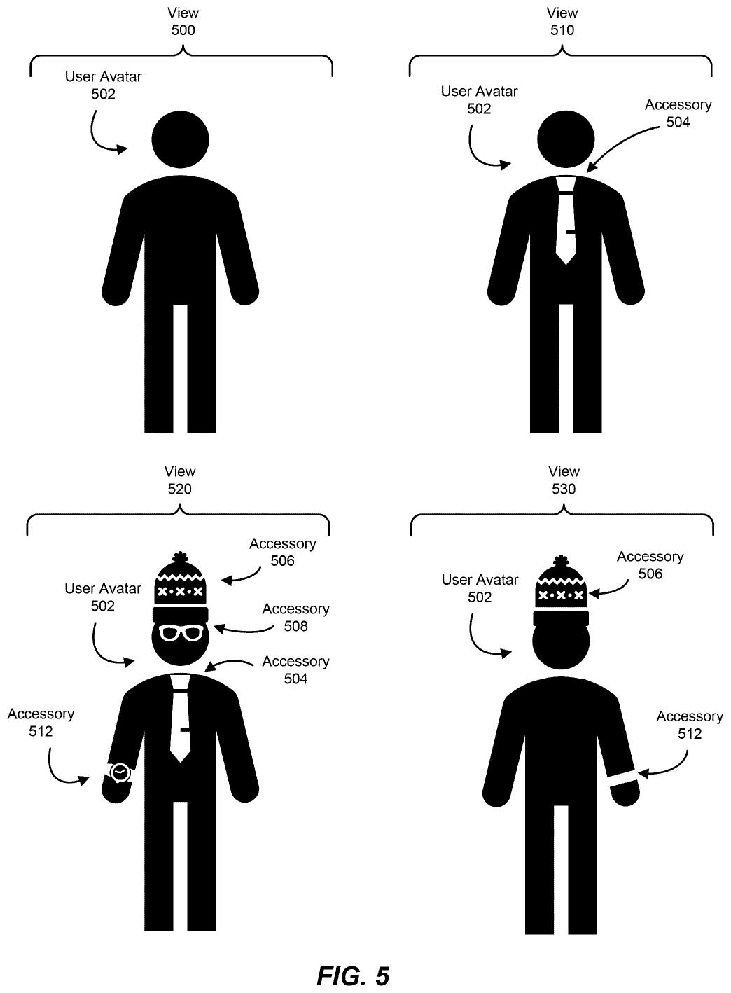

In one implementation, as illustrated in FIG. 5, a virtual fitting room may show a view 500 of a user avatar 502 that is an image of the user. In some examples, the systems described herein may receive one or more images of the user and may generate and/or isolate user avatar 502 based on the one or more images. For example, the systems described herein may remove a background from an image of the user to create user avatar 502. In another example, the systems described herein may use a generative ML model to generate user avatar 502 based on several images of the user.

In one example, as illustrated in view 510, the virtual fitting room may edit the image of user avatar 502 to display an accessory 504 on user avatar 502. In some implementations, a GUI may enable a user to select from various types, styles, and/or colors of accessories to try on in the virtual fitting room. For example, the systems described herein may enable a user to browse through a catalogue of available accessories, customize accessories (e.g., by changing the size and/or color), and/or import images of accessories to try on.

In some examples, as illustrated in view 520, the systems described herein may enable a user to virtually try on multiple accessories, such as accessories 504, 506, 508, and/or 512. In one implementation, the systems described herein may edit the image of the user in different locations in order to add each accessory. In some implementations, the systems described herein may maintain an edit history for the image in order to more easily revert edits when a user removes a given accessory. For example, the systems described herein may store a snapshot of user avatar 502 with no accessories and may edit segments of that snapshot into the image when an accessory is removed rather than using inpainting or other techniques to fill in the edited area.

In some implementations, the systems described herein may enable a user to view accessories in the virtual fitting room from multiple angles. For example, as illustrated in view 530, the virtual fitting room may enable a user to rotate the view of user avatar 502 to see various accessories from the back. In this example, the systems described herein may have access to images of the user and/or accessories from additional angles (e.g., from the back) and may use these images to create view 530. In one implementation, the systems described herein may store images of accessories from the front, side, back, and/or other angles. Additionally, or alternatively, the systems described herein may store three-dimensional models of accessories and/or user avatars. In some implementations, the systems described herein may receive a set of images of a given accessory under different conditions (e.g., rotation, lighting, etc.) and may be able to generate images of the accessory in novel views, poses, lighting conditions, and so forth.

FIG. 6 is a block diagram of a computing device according to some embodiments of the disclosure.

As illustrated, the device 600 includes a processor or central processing unit (CPU) such as CPU 602 in communication with a memory 604 via a bus 614. The device also includes one or more input/output (I/O) or peripheral devices 612. Examples of peripheral devices include, but are not limited to, network interfaces, audio interfaces, display devices, keypads, mice, keyboard, touch screens, illuminators, haptic interfaces, global positioning system (GPS) receivers, cameras, or other optical, thermal, or electromagnetic sensors.

In some embodiments, the CPU 602 may comprise a general-purpose CPU. The CPU 602 may comprise a single-core or multiple-core CPU. The CPU 602 may comprise a system-on-a-chip (SoC) or a similar embedded system. In some embodiments, a graphics processing unit (GPU) may be used in place of, or in combination with, a CPU 602. Memory 604 may comprise a memory system including a dynamic random-access memory (DRAM), static random-access memory (SRAM), Flash (e.g., NAND Flash), or combinations thereof. In one embodiment, the bus 614 may comprise a Peripheral Component Interconnect Express (PCIe) bus. In some embodiments, the bus 614 may comprise multiple busses instead of a single bus.

Memory 604 illustrates an example of a non-transitory computer storage media for the storage of information such as computer-readable instructions, data structures, program modules, or other data. Memory 604 can store a basic input/output system (BIOS) in read-only memory (ROM), such as ROM 608 for controlling the low-level operation of the device. The memory can also store an operating system in random-access memory (RAM) for controlling the operation of the device.

Applications 610 may include computer-executable instructions which, when executed by the device, perform any of the methods (or portions of the methods) described previously in the description of the preceding figures. In some embodiments, the software or programs implementing the method embodiments can be read from a hard disk drive (not illustrated) and temporarily stored in RAM 606 by CPU 602. CPU 602 may then read the software or data from RAM 606, process them, and store them in RAM 606 again.

The device may optionally communicate with a base station (not shown) or directly with another computing device. One or more network interfaces in peripheral devices 612 are sometimes referred to as a transceiver, transceiving device, or network interface card (NIC).

An audio interface in peripheral devices 612 produces and receives audio signals such as the sound of a human voice. For example, an audio interface may be coupled to a speaker and microphone (not shown) to enable telecommunication with others or generate an audio acknowledgment for some action. Displays in peripheral devices 612 may comprise liquid crystal display (LCD), gas plasma, light-emitting diode (LED), or any other type of display device used with a computing device. A display may also include a touch-sensitive screen arranged to receive input from an object such as a stylus or a digit from a human hand.

A keypad in peripheral devices 612 may comprise any input device arranged to receive input from a user. An illuminator in peripheral devices 612 may provide a status indication or provide light. The device can also comprise an input/output interface in peripheral devices 612 for communication with external devices, using communication technologies, such as USB, infrared, Bluetooth®, or the like. A haptic interface in peripheral devices 612 provides tactile feedback to a user of the client device.

A GPS receiver in peripheral devices 612 can determine the physical coordinates of the device on the surface of the Earth, which typically outputs a location as latitude and longitude values. A GPS receiver can also employ other geo-positioning mechanisms, including, but not limited to, triangulation, assisted GPS (AGPS), E-OTD, CI, SAI, ETA, BSS, or the like, to further determine the physical location of the device on the surface of the Earth. In one embodiment, however, the device may communicate through other components, providing other information that may be employed to determine the physical location of the device, including, for example, a media access control (MAC) address, Internet Protocol (IP) address, or the like.

The device may include more or fewer components than those shown in FIG. 6, depending on the deployment or usage of the device. For example, a server computing device, such as a rack-mounted server, may not include audio interfaces, displays, keypads, illuminators, haptic interfaces, Global Positioning System (GPS) receivers, or cameras/sensors. Some devices may include additional components not shown, such as graphics processing unit (GPU) devices, cryptographic co-processors, artificial intelligence (AI) accelerators, or other peripheral devices.

The subject matter disclosed above may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware, or any combination thereof (other than software per se). The preceding detailed description is, therefore, not intended to be taken in a limiting sense.

Throughout the specification and claims, terms may have nuanced meanings suggested or implied in context beyond an explicitly stated meaning. Likewise, the phrase “in an embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and,” “or,” or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general-purpose computer to alter its function as detailed herein, a special purpose computer, application-specific integrated circuit (ASIC), or other programmable data processing apparatus, such that the instructions, which execute via the processor of the computer or other programmable data processing apparatus, implement the functions/acts specified in the block diagrams or operational block or blocks. In some alternate implementations, the functions or acts noted in the blocks can occur out of the order noted in the operational illustrations. For example, two blocks shown in succession can in fact be executed substantially concurrently or the blocks can sometimes be executed in the reverse order, depending upon the functionality or acts involved.

We claim:

1. A method comprising:
identifying, by a processor, an image;
receiving, by the processor, natural language instructions for editing the image, the natural language instructions including a location within the image and an editing instruction;
editing, by a machine learning model executed by the processor, the location within the image based on the natural language instructions by:
identifying a region within the image that corresponds to the location in the natural language instructions; and
editing the identified region by applying the editing instruction to the identified region to generate an edited image; and
causing, by the processor, display of the edited image.

2. The method of claim 1, wherein identifying the region within the image that corresponds to the location in the natural language instructions comprises identifying a landmark location within the image that is described by the natural language instructions.

3. The method of claim 1, wherein identifying the region within the image that corresponds to the location in the natural language instructions comprises:
identifying a set of objects of a similar type depicted within the image; and
identifying, based on the natural language instructions, a specific object within the set of objects referred to by the natural language instructions.

4. The method of claim 1, wherein identifying the region within the image that corresponds to the location in the natural language instructions comprises:
identifying a type of object described by the natural language instructions; and
locating an object of the type within the image.

5. The method of claim 1, wherein identifying the region within the image that corresponds to the location in the natural language instructions comprises:
identifying a relative directional descriptor within the natural language instructions; and
identifying the region at least in part based on the relative directional descriptor.

6. The method of claim 1, further comprising training the machine learning model by:
identifying a set of triplets that each comprise:
an unmodified version of a training image;
text that comprises a description of a location within the unmodified version of the training image; and
a modified version of the training image that comprises a modification to the location described within the text; and
providing the set of triplets to the machine learning model as input data.

7. The method of claim 1, wherein the image comprises a frame of a video.

8. The method of claim 7, wherein editing, by the machine learning model executed by the processor, the location within the image based on the natural language instructions comprises editing consecutive frames of the video.

9. A non-transitory computer-readable storage medium for tangibly storing computer program instructions capable of being executed by a computer processor, the computer program instructions defining steps of:
identifying, by a processor, an image;
receiving, by the processor, natural language instructions for editing the image, the natural language instructions including a location within the image and an editing instruction;
editing, by a machine learning model executed by the processor, the location within the image based on the natural language instructions by:
identifying a region within the image that corresponds to the location in the natural language instructions; and
editing the identified region by applying the editing instruction to the identified region to generate an edited image; and
causing, by the processor, display of the edited image.

10. The non-transitory computer-readable storage medium of claim 9, wherein identifying the region within the image that corresponds to the location in the natural language instructions comprises identifying a landmark location within the image that is described by the natural language instructions.

11. The non-transitory computer-readable storage medium of claim 9, wherein identifying the region within the image that corresponds to the location in the natural language instructions comprises:
identifying a set of objects of a similar type depicted within the image; and
identifying, based on the natural language instructions, a specific object within the set of objects referred to by the natural language instructions.

12. The non-transitory computer-readable storage medium of claim 9, wherein identifying the region within the image that corresponds to the location in the natural language instructions comprises:
identifying a type of object described by the natural language instructions; and
locating an object of the type within the image.

13. The non-transitory computer-readable storage medium of claim 9, wherein identifying the region within the image that corresponds to the location in the natural language instructions comprises:
identifying a relative directional descriptor within the natural language instructions; and
identifying the region at least in part based on the relative directional descriptor.

14. The non-transitory computer-readable storage medium of claim 9, further comprising training the machine learning model by:
identifying a set of triplets that each comprise:
an unmodified version of a training image;
text that comprises a description of a location within the unmodified version of the training image; and
a modified version of the training image that comprises a modification to the location described within the text; and
providing the set of triplets to the machine learning model as input data.

15. The non-transitory computer-readable storage medium of claim 9, wherein the image comprises a frame of a video.

16. The non-transitory computer-readable storage medium of claim 15, wherein editing, by the machine learning model executed by the processor, the location within the image based on the natural language instructions comprises editing consecutive frames of the video.

17. A device comprising:
a processor; and
a storage medium for tangibly storing thereon logic for execution by the processor, the logic comprising instructions for:
identifying, by a processor, an image;
receiving, by the processor, natural language instructions for editing the image, the natural language instructions including a location within the image and an editing instruction;
editing, by a machine learning model executed by the processor, the location within the image based on the natural language instructions by:
identifying a region within the image that corresponds to the location in the natural language instructions; and
editing the identified region by applying the editing instruction to the identified region to generate an edited image; and
causing, by the processor, display of the edited image.

18. The device of claim 17, wherein identifying the region within the image that corresponds to the location in the natural language instructions comprises identifying a landmark location within the image that is described by the natural language instructions.

19. The device of claim 17, wherein identifying the region within the image that corresponds to the location in the natural language instructions comprises:
identifying a set of objects of a similar type depicted within the image; and
identifying, based on the natural language instructions, a specific object within the set of objects referred to by the natural language instructions.

20. The device of claim 17, wherein identifying the region within the image that corresponds to the location in the natural language instructions comprises:
identifying a type of object described by the natural language instructions; and
locating an object of the type within the image.
